(19) United States
(12) Patent Application Publication
(10) Pub. No.: US 2010/0195826 A1
(43) Pub. Date: Aug. 5, 2010

(54) SYSTEM FOR PERSONAL IP BROADCASTING SERVICE WITH PERSONAL DRM AND METHOD USING THE SAME

(75) Inventors: Sung-Yong Lee, Wonju (KR); Byung-Tak Lee, Suwon (KR); Seung-Hun Oh, Seoul (KR); Ho-Young Song, Daejeon (KR); Bong-Tae Kim, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon (KR)

(21) Appl. No.: 12/443,683

(22) PCT Filed: Jun. 15, 2007
(86) PCT No.: PCT/KR07/02898

§ 371 Date: Mar. 30, 2009

(30) Foreign Application Priority Data
Sep. 29, 2006 (KR) 10-2006-0096410

(51) Int. Cl. H04N 7/167

(52) U.S. Cl. 380/200

(57) ABSTRACT

A system for personal Internet protocol (IP) broadcasting to which a personal digital rights management (DRM) is applied, and a method thereof are provided. The system for personal IP broadcasting includes: a personal broadcasting transmission unit generating content, storing the content, applying personal DRM encryption to the content, and transmitting the content; a personal broadcasting reception unit receiving the transmitted content, DRM-decoding the content based on a personal DRM certificate corresponding to the content, and reproducing the content; a channel management unit allocating a channel through which the personal broadcasting transmission unit transmits broadcasting, then managing the channel, and transmitting information of a predetermined broadcasting transmission unit requested by the personal broadcasting reception unit; and an authentication server unit verifying validity of each of the personal broadcasting transmission unit and the personal broadcasting reception unit, and issuing and managing the personal DRM certificate. According to the system and method, DRM is applied to the content authored and broadcast by an individual person, thereby enabling the person to claim digital rights. Accordingly, illegal copying of the personal broadcasting content can be prevented and only authenticated users can use the service, thereby preventing broadcasting of inappropriate content or illegal use of the service by an unauthorized user.

### TECHNICAL FIELD

The present invention relates to a system in which personal digital rights management (DRM) is applied to a personal Internet protocol (IP) broadcasting, and a method thereof , and more particularly, to a system in which if a personal IP broadcasting transmitter whose validity is authenticated by an authentication server applies personal DRM to content authored by the IP broadcasting transmitter, and broadcasts the content, only a broadcasting receiver whose validity is authenticated by the authentication server receives the broadcasting, thereby enabling the rights on the digital content authored by the individual, to be guaranteed, and a method thereof.

### BACKGROUND ART

Recently, with the development of camera technologies, rapid penetration of ultra high-speed communication networks, and the development of efficient compression technologies for video and audio signals, personal Internet protocol (IP) broadcasting with Internet users as viewers, has been enabled. In most cases, digital content used in personal IP broadcasting is authored by individuals or digital content authored by others is retransmitted. The personal IP broadcasting is transmitted to many and unspecified persons, and according to circumstances, personal broadcasting services are provided only to broadcasting receiver users who are authenticated in advance in order to protect privacy of the content. If a user accesses a personal broadcasting program requiring user authentication, the user should follow an authentication procedure specified by the personal transmitting the broadcasting program.

Though it is thus important to authenticate a user who desired to transmit or receive personal IP broadcasting, protection of rights on digital content authored by an individual is also important. For this, as a method of protecting rights on digital content, DRM is widely used at present. The DRM is a technology which integratedly supports digital content from authoring to distribution and management, including safe protection of the rights and profits of a digital content provider, prevention of illegal copying, and performing of an agent role for royalty payment and settlement. The DRM includes all of digital copyright management technology, software and security technologies for approving copyright license and execution, and payment and settlement technologies.

At present, the DRM is easily applied to copyright protection of audio files and music videos. Also, management of electronics books (eBook), such as View, Modify, Copy, Print, Re-distribution, is perfectly implemented, thereby enabling perfect protection of rights of authors, distributors, publishers, service providers and users. The DRM is also widely used for protection of content of digital image media, such as DVDs.

Accordingly, there is a necessity for applying the DRM that is widely used for copyright protection of digital content, to personal IP broadcasting, thereby protecting copyright of digital content authored by individuals.

### DISCLOSURE OF INVENTION

### Technical Problem

The present invention provides a system in which if a personal Internet protocol (IP) broadcasting transmitter whose validity is authenticated by an authentication server applies personal digital rights management (DRM) to content authored by the IP broadcasting transmitter, and broadcasts the content, only a broadcasting receiver whose validity is authenticated by the authentication server receives the broadcasting, thereby enabling the rights on the digital content authored by the individual, to be guaranteed, and a method thereof.

### Technical Solution

According to an aspect of the present invention, there is provided a personal Internet protocol (IP) broadcasting service system to which a personal digital rights management (DRM) is applied, the system including: a personal broadcasting transmission unit generating content, storing the content, applying personal DRM encryption to the content, and transmitting the content; a personal broadcasting reception unit receiving the transmitted content, DRM-decoding the content based on a personal DRM certificate corresponding to the content, and reproducing the content; a channel management unit allocating a channel through which the personal broadcasting transmission unit transmits broadcasting, then managing the channel, and transmitting information of a predetermined broadcasting transmission unit requested by the personal broadcasting reception unit; and an authentication server unit verifying validity of each of the personal broadcasting transmission unit and the personal broadcasting reception unit, and issuing and managing the personal DRM certificate.

According to another aspect of the present invention, there is provided a personal IP broadcasting service method to which a personal DRM is applied, wherein a personal broadcasting transmission unit performs personal DRM encryption of content based on a personal DRM certificate and rules provided by an authentication server, and transmits the encrypted content, and a reception unit receives the encrypted content, the method including: according to request of the personal broadcasting transmission unit, transmitting the personal DRM certificate and the personal DRM rules; based on the personal DRM certificate and the personal DRM rules, encrypting already generated content and transmitting the encrypted content through an allocated channel; and the reception unit receiving the personal DRM certificate and the personal DRM rules applied to the content, from the authentication server unit, decoding the encrypted content, and reproducing the content.

### ADVANTAGEOUS EFFECTS

According to the system and method for providing a personal IP broadcasting service to which personal DRM is applied according to the present invention as described above, in the method of applying the personal DRM to the personal IP broadcasting, the validity of each of the broadcasting transmitter and the broadcasting receiver is verified according to a user authentication method defined in the authentication server unit in order to receive the personal IP broadcasting service, thereby making management of users easier.

Also, since the digital rights of the content authored by individual are protected by the personal DRM, illegal copying or distribution of the content can be prevented. This is not performed through direct communication between the broadcasting transmitter and the broadcasting receiver, but this is processed through a consistent method defined in the authentication server unit and the channel management server, thereby making management of user information or channel information easier.

In the present invention, the user validity of the broadcasting transmitter and the broadcasting receiver should be verified in a separate authentication server in order to use the personal IP broadcasting service. Accordingly, transparency of the broadcasting transmitter and receiver using the personal IP broadcasting can be provided. In addition, since the content authored by an individual is broadcast after a personal DRM certificate issued by the authentication server is applied to the content, the digital rights on the content authored by the individual can be protected.

### DESCRIPTION OF DRAWINGS

FIG. 1 is a block diagram illustrating a structure of a personal Internet protocol (IP) broadcasting service system to which a personal digital rights management (DRM) is applied according to an embodiment of the present invention;

FIG. 2 is a detailed block diagram of a personal broadcasting transmission unit illustrated in FIG. 1 according to an embodiment of the present invention;

FIG. 3 is a detailed block diagram of an authentication server illustrated in FIG. 1 according to an embodiment of the present invention;

FIG. 4 is a flowchart illustrating a process of a method of providing a personal IP broadcasting service to which personal DRM is applied according to an embodiment of the present invention;

FIG. 5 is a flowchart illustrating a process in which the validity of a broadcasting transmitter is authenticated in an authentication server and a valid personal DRM certificate is given to the broadcasting transmitter according to an embodiment of the present invention;

FIG. 6 is a flowchart illustrating a process required for a broadcasting transmitter to broadcast content authored by the broadcasting transmitter according to an embodiment of the present invention; and

FIG. 7 is a flowchart illustrating a process required for a broadcasting receiver to receive personal broadcasting content broadcast by a broadcasting transmitter according to an embodiment of the present invention.

### BEST MODE

According to an aspect of the present invention, there is provided a personal Internet protocol (IP) broadcasting service system to which a personal digital rights management (DRM) is applied, the system including: a personal broadcasting transmission unit generating content, storing the content, applying personal DRM encryption to the content, and transmitting the content; a personal broadcasting reception unit receiving the transmitted content, DRM-decoding the content based on a personal DRM certificate corresponding to the content, and reproducing the content; a channel management unit allocating a channel through which the personal broadcasting transmission unit transmits broadcasting, then managing the channel, and transmitting information of a predetermined broadcasting transmission unit requested by the personal broadcasting reception unit; and an authentication server unit verifying validity of each of the personal broadcasting transmission unit and the personal broadcasting reception unit, and issuing and managing the personal DRM certificate.

According to another aspect of the present invention, there is provided a personal IP broadcasting service method to which a personal DRM is applied, wherein a personal broadcasting transmission unit performs personal DRM encryption of content based on a personal DRM certificate and rules provided by an authentication server, and transmits the encrypted content, and a reception unit receives the encrypted content, the method including: according to request of the personal broadcasting transmission unit, transmitting the personal DRM certificate and the personal DRM rules; based on the personal DRM certificate and the personal DRM rules, encrypting already generated content and transmitting the encrypted content through an allocated channel; and the reception unit receiving the personal DRM certificate and the personal DRM rules applied to the content, from the authentication server unit, decoding the encrypted content, and reproducing the content.

### MODE FOR INVENTION

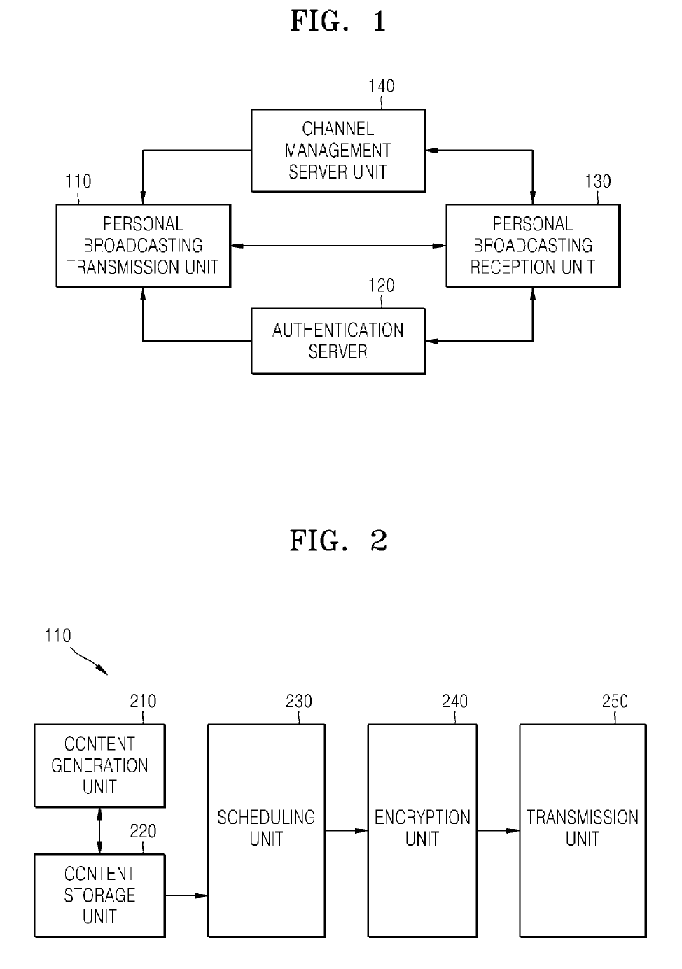

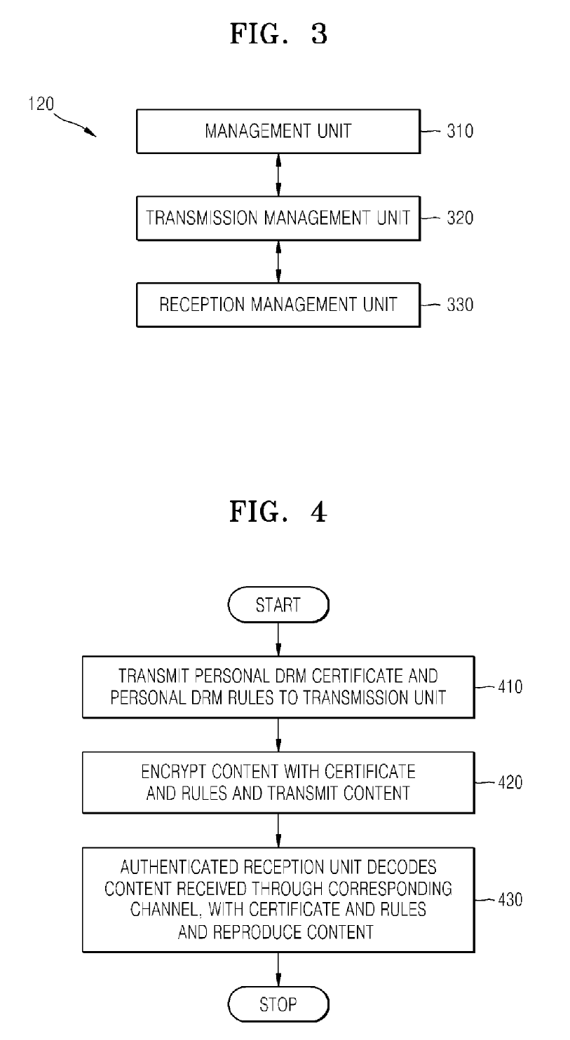

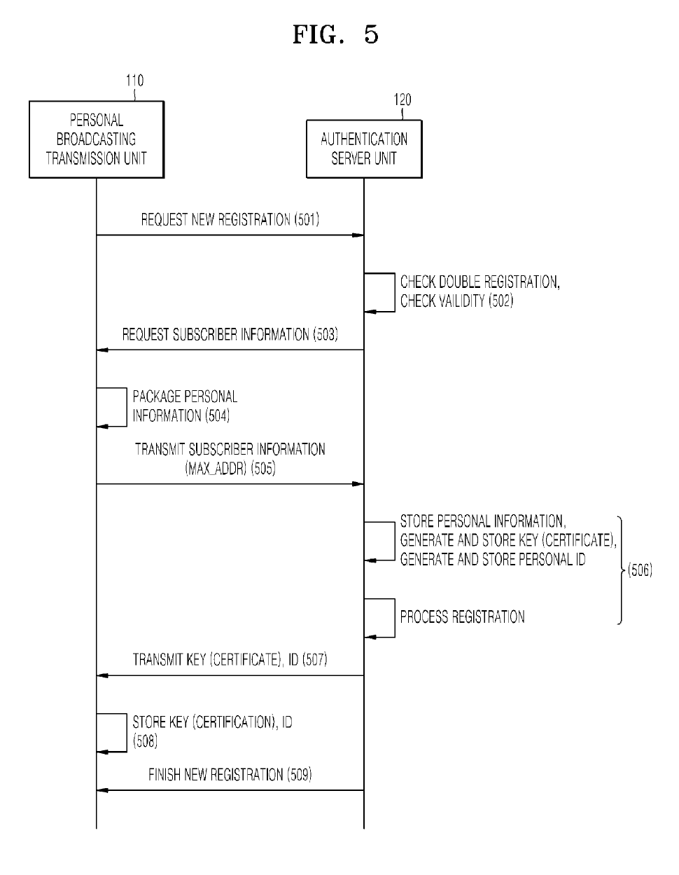

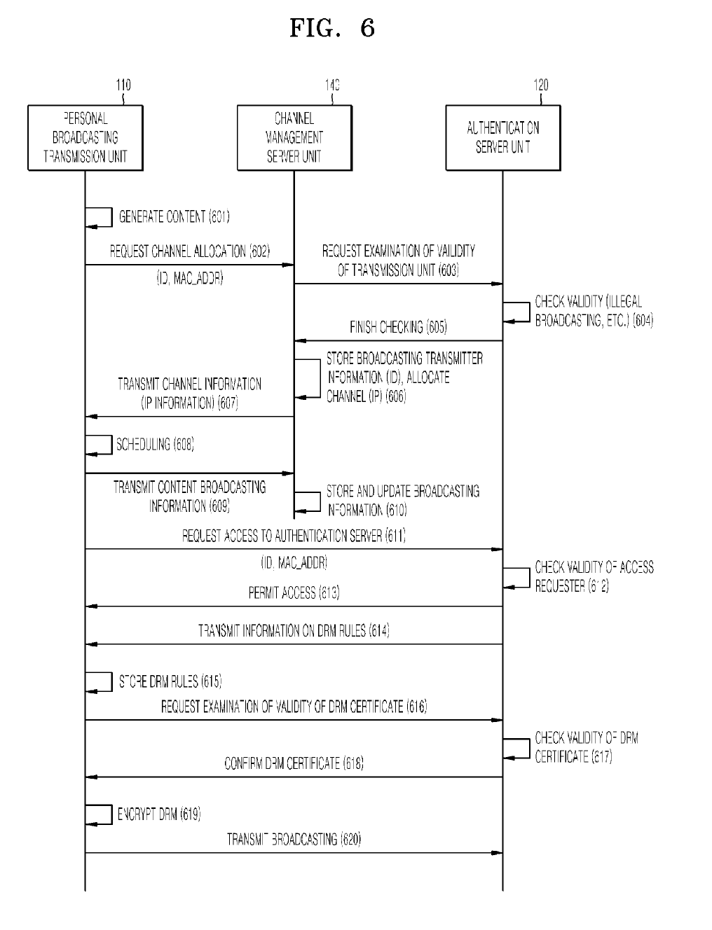

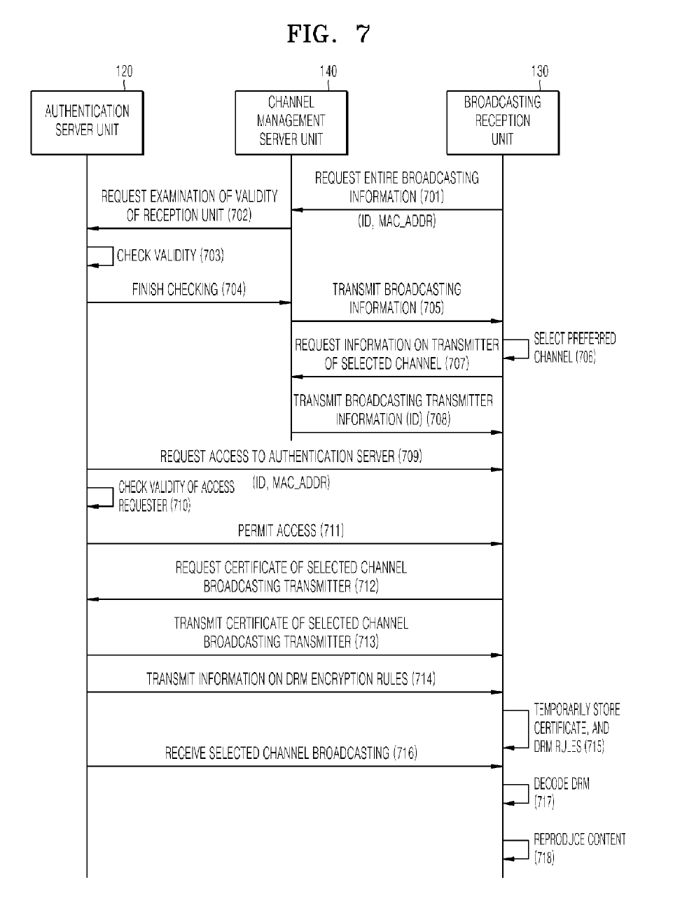

The present invention will now be described more fully with reference to the accompanying drawings, in which exemplary embodiments of the invention are shown. FIG. 1 is a block diagram illustrating a structure of a personal Internet protocol (IP) broadcasting service system to which a personal digital rights management (DRM) is applied according to an embodiment of the present invention, and FIG. 2 is a detailed block diagram of a personal broadcasting transmission unit illustrated in FIG. 1 according to an embodiment of the present invention. FIG. 3 is a detailed block diagram of an authentication server illustrated in FIG. 1 according to an embodiment of the present invention, and FIG. 4 is a flowchart illustrating a process of a method of providing a personal IP broadcasting service to which personal DRM is applied according to an embodiment of the present invention. FIG. 5 is a flowchart illustrating a process in which the validity of a broadcasting transmitter is authenticated in an authentication server and a valid personal DRM certificate is given to the broadcasting transmitter according to an embodiment of the present invention, and FIG. 6 is a flowchart illustrating a process required for a broadcasting transmitter to broadcast content authored by the broadcasting transmitter according to an embodiment of the present invention. FIG. 7 is a flowchart illustrating a process required for a broadcasting receiver to receive personal broadcasting content broadcast by a broadcasting transmitter according to an embodiment of the present invention.

First, referring to FIG. 1, a personal broadcasting transmission unit 110 generates digital content, then stores the content, and later provides the content for broadcasting. When the content is broadcast, personal DRM encryption is applied to the content and then broadcast.

A personal broadcasting reception unit 130 receives the content transmitted by the personal broadcasting transmission unit 110, and receives a personal DRM certificate and DRM encryption rules corresponding to the content provided by an authentication server unit 120, thereby DRM-decoding the content in real-time and then reproducing the content.

The authentication server unit 120 verifies validity of each of the personal broadcasting transmission unit 110 and the personal broadcasting reception unit 130, and issues and manages the personal DRM certificate.

Meanwhile, a channel management server unit 140 allocates a channel through which the personal broadcasting transmission unit 110 transmits broadcasting, then manages the channel, and transmits information on a predetermined broadcasting transmission unit requested by the personal broadcasting reception unit 130.

At this time, the authentication server unit 120 and the channel management server unit 149 that are external systems may be integrated and then, managed and operated, or may be operated as separate systems.

The personal broadcasting transmission unit 110 will now be explained in more detail with reference to FIG. 2.

A content generation unit 210 generates content desired to be transmitted, and a content storage unit 220 stores the generated content and when necessary, outputs the content.

A scheduling unit 230 arranges the content according to a channel allocated by the channel management server unit 140, and outputs the content.

An encryption unit 240 performs personal DRM encryption of each content arranged by the scheduling unit 230, based on the predetermined DRM encryption rules and personal DRM certificates transmitted by the authentication server unit 120. Finally, a transmission unit 250 transmits the encrypted content to a wireless segment.

Referring to FIG. 3, the authentication server unit 120 will now be explained in more detail.

A management unit 310 defines and manages DRM rules which the personal broadcasting transmission unit 110 will use for DRM encryption.

A transmission management unit 320 generates a personal DRM certificate based on personal information of a user who wants to broadcast using the personal broadcasting transmission unit, and provides the DRM certificate if it is requested. However, the transmission management unit 320 may provide the personal DRM certificate only when personal information is registered in advance. Here, the personal DRM certificate may be generated based on a media access control (MAC) address and a personal identification (ID) issued by the authentication server unit 120. Finally, a reception management unit 330 generates and provides the DRM certificate based on personal information of a receiver who wants to receive broadcasting by using the personal broadcasting reception unit 130.

A method of providing a personal IP broadcasting service to which personal DRM is applied according to an embodiment of the present invention will now be explained with reference to FIGS. 4 through 7.

First, the authentication server unit 120 transmits a personal DRM certificate and personal DRM rules according to a request of the personal broadcasting transmission unit 110.

For this, first, authentication of the personal broadcasting transmission unit 110 is performed, and if the authentication is successful, the personal DRM certificate is generated by combining the MAC address used by the individual and the ID generated by the authentication server unit 120, and then, transmitted in operation S410.

The personal broadcasting transmission unit 110 generates and stores content, performs scheduling for arranging content, then encrypts the generated content based on the personal DRM certificate and personal DRM rules, and transmits the encrypted content to an allocated channel in operation 420.

Meanwhile, the broadcasting reception unit 130 receives all channel information on contents currently being broadcast, then, selects one channel desired to be received, and requests the authentication server unit 120 to provide the personal DRM certificate and DRM encryption rules of the transmitter transmitting broadcasting through the selected channel. If the personal DRM certificate and the DRM encryption rules are normally received, the content is DRM-decoded based on these, and reproduced in operation 430.

FIG. 5 is a flowchart illustrating a process in which in order to use the personal ID broadcasting server provided as illustrated in FIG. 1, the validity of each of a broadcasting transmitter and a broadcasting receiver is authenticated in the authentication server 120 and a valid personal DRM certificate is given to the broadcasting transmitter according to an embodiment of the present invention.

Though only the personal broadcasting transmission unit 110 is illustrated, the process is applied to the personal broadcasting reception unit 130 in the same manner. In order to transmit broadcasting in the personal broadcasting transmission unit 110 or to receive broadcasting in the personal broadcasting reception unit 130, a new registration is requested to the authentication server unit in operation 501. Then, the authentication server unit 120 checks whether or not the registration is a double registration, and then begins to verify the validity of the personal broadcasting transmission unit 110 or the personal broadcasting reception unit 130 in operation 502. For this, if subscriber information is requested in operation 503, the personal broadcasting transmission unit 110 packages personal information according to this request in operation 504, and transmits the subscriber information including the MAC address of the personal broadcasting transmission unit 110 in operation 505. If the subscriber information is received, the authentication server unit 120 stores the personal information, then generates and stores a key (a certificate), and generates and stores a personal broadcasting ID, thereby finishing the registration process in operation 506. Then, if the generated key (certificate) and ID are transmitted to the personal broadcasting transmission unit 110, the personal broadcasting transmission unit 110 receives and stores the key and ID in operation 508, thereby completing the new registration in operation 509. Meanwhile, the personal DRM certificate may be issued only to the personal broadcasting transmitter or may be issued to both the personal broadcasting transmitter and receiver. The certificate of the personal DRM may be generated by using a combination of the MAC address of the individual and the ID generated in the authentication server unit 120.

FIG. 6 is a sequence diagram illustrating a process required for the personal broadcasting transmission unit 110 to broadcast by using the personal IP broadcasting service provided according to the embodiment as illustrated in FIG. 1. In order to broadcast, the personal broadcasting transmission unit 110 is authenticated by the authentication server unit 120 and the channel management server unit 140, and is allocated first a channel formed with an IP address. After the broadcasting transmission unit 110 is allocated the broadcasting channel, and before broadcasting the content generated by the broadcasting transmission unit 110 according to scheduling, the broadcasting transmission unit 110 makes the validity of the DRM certificate kept in the broadcasting transmission unit 110, verified by the authentication server unit 120. Then, with encrypting the broadcasting content with its DRM certificates, the broadcasting transmission unit 110 transmits the encrypted content. At this time, the broadcasting transmitter may perform DRM encryption by receiving DRM encryption rules arbitrarily selected among a variety of DRM encryption rules already defined in the authentication server unit 120. More specifically, the personal broadcasting transmission unit 120 generates content to be broadcast in operation 601, and if the personal broadcasting transmission unit 110 requests the channel management server unit 140 to allocate a channel in operation 602, the channel management server unit 140 requests the authentication server unit 120 to verify the validity of the transmission unit in operation 603. The authentication server unit 120 performs a validity examination in operation 604, and then, indicates the completion of the examination to the channel management server unit 140 in operation 605. According to this, the channel management unit 140 stores information of the broadcasting transmitter and allocates a channel to the broadcasting transmitter in operation 606. After receiving information on the allocated channel in operation 607, the personal broadcasting transmission unit 110 performs the scheduling as described above, in operation 608, and transmits content broadcasting information to the channel management server unit 140 in operation 609. The channel management server unit 140 stores and updates the received broadcasting information in operation 610.

Then, if the personal broadcasting transmission unit 110 requests an access to the authentication server unit 120 in operation 611, the authentication server unit 120 verifies the validity of the request in operation 612, and if the request is valid, the authentication server unit 120 permits the access in operation 613. If the authentication server 120 transmits information on DRM rules at the same time in operation 614, the personal broadcasting transmission unit 110 stores the rules in operation 615, and request the authentication server unit 120 to verify the validity of a DRM certificate in operation 616. If the confirmation result of the authentication server unit 120 indicates that the DRM certificate is valid, the personal broadcasting transmission unit 110 encrypts content according to the DRM certificate and DRM rules, and transmits the broadcasting in operations 617 through 620.

FIG. 7 is a sequence diagram illustrating a process required for the personal broadcasting reception unit 130 to receive personal broadcasting content provided according to an embodiment of the present invention as illustrated in FIG. 1. If the personal broadcasting reception unit 130 requests the channel management server unit 140 to provide all channel information on contents currently being broadcast in order to receive personal broadcasting in operation 701, the channel management server unit 140 confirms the validity of the personal broadcasting reception unit 130 through the authentication server unit 120, and only when the authentication is successful, the channel management server unit 140 transmits the requested broadcasting information in operation 702 through 705. At this time, the requested information on channel being broadcast may be provided only to a broadcasting reception requester whose validity is verified in the authentication server unit 120 and the channel management server unit 140.

If the information on channels from the channel management server unit 140 is received, the personal broadcasting reception unit 130 selects a preferred channel in operation 706, requests the authentication server unit 120 to provide information on a transmitter transmitting broadcasting through the selected channel and receives the information in operations 707 and 708. Then, the personal broadcasting reception unit 130 accesses the authentication server unit 120, follows a required authentication procedure in operations 709 through 711, and then, if the authentication is successful, the personal broadcasting reception unit 130 requests the personal DRM certificate of the transmitter and then, receives the DRM certificate in operations 712 and 713. If the personal DRM certificate of the broadcasting transmitter selected in the personal broadcasting reception unit 130 and DRM encryption rules used for DRM encryption by the broadcasting transmitter are received at the same time in operation 714, the personal broadcasting reception unit 130 temporarily stores the personal DRM certificate and the DRM encryption rules in operation 715. Then, while receiving the broadcasting through the selected channel in operation 716, the personal broadcasting reception unit 130 DRM-decodes the received content in real-time in operation 717, and finally reproduces the content in operation 718.

According to the system and method for providing a personal IP broadcasting service to which personal DRM is applied according to the present invention as described above, in the method of applying the personal DRM to the personal IP broadcasting, the validity of each of the broadcasting transmitter and the broadcasting receiver is verified according to a user authentication method defined in the authentication server unit in order to receive the personal IP broadcasting service, thereby making management of users easier.

Also, since the digital rights of the content authored by individual are protected by the personal DRM, illegal copying or distribution of the content can be prevented. This is not performed through direct communication between the broadcasting transmitter and the broadcasting receiver, but this is processed through a consistent method defined in the authentication server unit and the channel management server, thereby making management of user information or channel information easier.

In the present invention, the user validity of the broadcasting transmitter and the broadcasting receiver should be verified in a separate authentication server in order to use the personal IP broadcasting service. Accordingly, transparency of the broadcasting transmitter and receiver using the personal IP broadcasting can be provided. In addition, since the content authored by an individual is broadcast after a personal DRM certificate issued by the authentication server is applied to the content, the digital rights on the content authored by the individual can be protected.

The present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

While the present invention has been particularly shown and described with reference to exemplary embodiments thereof, it will be understood by those of ordinary skill in the art that various changes in form and details may be made therein without departing from the spirit and scope of the present invention as defined by the following claims.

The preferred embodiments should be considered in descriptive sense only and not for purposes of limitation. Therefore, the scope of the invention is defined not by the detailed description of the invention but by the appended claims, and all differences within the scope will be construed as being included in the present invention.

### INDUSTRIAL APPLICABILITY

The present invention relates to a system in which personal digital rights management (DRM) is applied to a personal Internet protocol (IP) broadcasting, and a method thereof , and more particularly, to a system in which if a personal IP broadcasting transmitter whose validity is authenticated by an authentication server applies personal DRM to content authored by the IP broadcasting transmitter, and broadcasts the content, only a broadcasting receiver whose validity is authenticated by the authentication server receives the broadcasting, thereby enabling the rights on the digital content authored by the individual, to be guaranteed, and a method thereof.

1. A personal Internet protocol (IP) broadcasting service system to which a personal digital rights management (DRM) is applied, the system comprising:
a personal broadcasting transmission unit generating content, storing the content, applying personal DRM encryption to the content, and transmitting the content;
a personal broadcasting reception unit receiving the transmitted content, DRM-decoding the content based on a personal DRM certificate corresponding to the content, and reproducing the content;
a channel management unit allocating a channel through which the personal broadcasting transmission unit transmits broadcasting, then managing the channel, and transmitting information of a predetermined broadcasting transmission unit requested by the personal broadcasting reception unit; and
an authentication server unit verifying validity of each of the personal broadcasting transmission unit and the personal broadcasting reception unit, and issuing and managing the personal DRM certificate.

2. The system of claim 1, wherein the personal broadcasting transmission unit comprises:
a content generation unit generating the content;
a content storage unit storing the generated content;
a scheduling unit arranging the content according to the allocated channel and outputting the content;
an encryption unit performing personal DRM encryption of each of the content arranged by the scheduling unit, based on the personal DRM certificate transmitted by the authentication server; and
a transmission unit transmitting the encrypted content.

3. The system of claim 1, wherein the authentication server unit comprises:
a management unit defining DRM rules to be used for DRM encryption by the personal broadcasting transmission unit, and managing the DRM rules;
a transmission management unit generating a personal DRM certificate based on personal information of a user who wants to broadcast by using the personal broadcasting transmission unit, and providing the personal DRM certificate; and
a reception management unit generating the personal DRM certificate based on personal information of a receiver who wants to receive broadcasting by using the personal broadcasting reception unit.

4. The system of claim 3, wherein the authentication server unit issues the personal DRM certificate only when personal information is registered in advance.

5. The system of claim 4, wherein the personal DRM certificate is generated based on a media access control (MAC) address and a personal identification (ID) issued by the authentication server unit.

6. The system of claim 2, wherein the encryption unit performs DRM encryption of the content by using predetermined DRM encryption rules defined and then transmitted by the authentication server unit and the personal DRM certificate.

7. The system of claim 1, wherein the personal broadcasting reception unit receives the personal DRM certificate and the DRM encryption rules used by the broadcasting transmission unit, transmitted by the authentication server, and based on the personal DRM certificate and the DRM encryption rules, the personal broadcasting reception unit DRM-decodes the content in real-time and reproduces the content.

8. A personal IP broadcasting service method to which a personal DRM is applied, wherein a personal broadcasting transmission unit performs personal DRM encryption of content based on a personal DRM certificate and rules provided by an authentication server, and transmits the encrypted content, and a reception unit receives the encrypted content, the method comprising:
according to request of the personal broadcasting transmission unit, transmitting the personal DRM certificate and the personal DRM rules;
based on the personal DRM certificate and the personal DRM rules, encrypting already generated content and transmitting the encrypted content through an allocated channel; and
the reception unit receiving the personal DRM certificate and the personal DRM rules applied to the content, from the authentication server unit, decoding the encrypted content, and reproducing the content.

9. The method of claim 8, wherein the transmitting of the personal DRM certificate and the personal DRM rules comprises:
authenticating the personal broadcasting transmission unit; and
if the authentication is successful, combining the MAC address used by the personal broadcasting unit and the ID generated by the authentication server unit, thereby generating the personal DRM certificate.

10. The method of claim 8, wherein the encrypting of the already generated content and the transmitting of the encrypted content through an allocated channel comprise:
generating and storing the content;
performing scheduling to arrange the content according to the allocated channel; and
performing personal DRM encryption of each content arranged according to the scheduling, based on the personal DRM certificate, and transmitting the encrypted content.

11. The method of claim 8, wherein the receiving of the personal DRM certificate and the personal DRM rules applied to the content, from the authentication server unit, the decoding of the encrypted content, and the reproducing of the content by the reception unit comprise:
receiving all channel information of contents being broadcast, and selecting one channel;
requesting the authentication server to provide the personal DRM certificate and the DRM encryption rules of a transmitter transmitting broadcasting through the selected channel; and
DRM-decoding content based on the personal DRM certificate and the DRM encryption rules normally received.

12. A computer readable recording medium having embodied thereon a computer program for executing a personal IP broadcasting service method to which a personal DRM is applied, wherein a personal broadcasting transmission unit performs personal DRM encryption of content based on a personal DRM certificate and rules provided by an authentication server, and transmits the encrypted content, and a reception unit receives the encrypted content, and the personal IP broadcasting service method comprises:
according to request of the personal broadcasting transmission unit, transmitting the personal DRM certificate and the personal DRM rules;
based on the personal DRM certificate and the personal DRM rules, encrypting already generated content and transmitting the encrypted content through an allocated channel; and
the reception unit receiving the personal DRM certificate and the personal DRM rules applied to the content, from the authentication server unit, decoding the encrypted content, and reproducing the content.
